(19) United States
(12) Patent Application Publication
(10) Pub. No.: US 2017/0032502 A1
(43) Pub. Date: Feb. 2, 2017

(54) IMAGE PROCESSING

(71) Applicant: Optos PLC, Dunfermline (GB)

(72) Inventors: Jano van Hemert, Edinburgh (GB); Alan Fleming, Edinburgh (GB); David Clifton, Edinburgh (GB)

(21) Appl. No.: 15/222,728

(22) Filed: Jul. 28, 2016

(30) Foreign Application Priority Data
Jul. 30, 2015 (GB) 1513449.7

(51) Int. Cl. G06T 5/00

(52) U.S. Cl. CPC G06T 5/003; G06T 5/006

(57) ABSTRACT

The present disclosure provides a method of processing an image comprising receiving a measured image, producing a sharpened image by filtering the measured image to increase its sharpness, and transforming the sharpened image using at least one selected geometric transformation. The present disclosure further provides a computer readable media storing program instructions which, when executed, perform the method of processing an image and a system for processing an image comprising a receiving module which receives a measured image, a sharpening module which produces a sharpened image by filtering the measured image to increase its sharpness, and a transformation module which transforms the sharpened image using at least one selected geometric transformation.

### CROSS REFERENCE TO RELATED APPLICATIONS

The present application claims priority to and the benefit of United Kingdom Patent Application No. GB1513449.7 titled “IMAGE PROCESSING” filed Jul. 30, 2015, the entire content of which is incorporated herein by reference in its entirety for all purposes.

### FIELD OF DISCLOSURE

The present solution relates to image processing, particularly sharpening and transformation of images.

### BACKGROUND

Images are produced by a variety of image sensors in many, diverse applications. For example, image sensors use light and other electromagnetic radiation to produce images of objects in photography, cinematography, radar, medical imaging etc. In several applications, one or more geometric transformations are applied to an image, for example to display the image to a user. As is common knowledge, geometric transformations of images, which is also referred to as warping, involves a process of resampling of the image data. The transformation resampling often involves interpolation of the image data. This results in distortion of the image such as blurring of the image and may introduce unwanted aliasing and other forms of image quality degradation. Prior art solutions to this problem have focused on different techniques for the sampling process for the transformations, with limited success.

### SUMMARY

According to a first aspect of the present solution there is provided a method of processing an image comprising

receiving a measured image,

producing a sharpened image by filtering the measured image to increase its sharpness,

transforming the sharpened image using at least one selected geometric transformation.

Filtering the measured image to increase its sharpness may comprise contrast enhancement of the measured image.

Contrast enhancement of the measured image may comprise determining a plurality of regions of interest of the image,

characterising contrast between image intensity of a region of interest and image intensity of at least one adjacent region of interest,

adjusting the image intensity in the region of interest or adjusting the image intensity in the at least one adjacent region of interest or adjusting the image intensity in the region of interest and the at least one adjacent region of interest to enhance the contrast between the image intensity of the region of interest and the image intensity of the at least one adjacent region of interest.

Adjusting the image intensity of the region of interest may comprise changing image intensity of one or more edge sections of the region of interest of the image. Adjusting the image intensity of the at least one adjacent region of interest may comprise changing image intensity of one or more edge sections of the at least one adjacent region of interest of the image.

Characterising the contrast between the image intensity of the region of interest and the image intensity of the at least one adjacent region of interest may comprise measuring the second derivative of the image intensity of the region of interest and measuring the second derivative of the image intensity of the at least one adjacent region of interest.

The measured image may comprise a set of pixels and contrast enhancement of the measured image may comprise

determining a plurality of regions of interest of the image, each comprising a plurality of pixels, characterising contrast between image intensity of at least some of the pixels of a region of interest and image intensity of at least some of the pixels of at least one adjacent region of interest,

adjusting the image intensity of the at least some of the pixels of the region of interest or adjusting the image intensity of the at least some of the pixels of the at least one adjacent region of interest or adjusting the image intensity of the at least some of the pixels of the region of interest and the at least some of the pixels of the at least one adjacent region of interest to enhance the contrast between the image intensity of the at least some of the pixels of the region of interest and the image intensity of the at least some of the pixels of the at least one adjacent region of interest.

Adjusting intensity of the region of interest may comprise changing intensity of at least some of the pixels of one or more edge sections of the region of interest of the image. Adjusting the image intensity of the at least one adjacent region of interest may comprise changing intensity of at least some of the pixels of one or more edge sections of the at least one adjacent region of interest of the image.

Contrast enhancement of the measured image may comprise

determining a plurality of regions of interest of the image, characterising image intensity of the plurality of regions of interest,

contrast stretching of the plurality of regions of interest by choosing a desired level of sharpening, calculating a scaling function using the level of sharpening and the characterisation of the image intensity of the plurality of regions of interest, and using the scaling function to change the image intensity of the plurality of regions of interest.

Contrast enhancement of the measured image may comprise unsharp masking of the image.

Contrast enhancement of the measured image may comprise convolution between the image and a kernel.

Contrast enhancement of the measured image may comprise contrast limited adaptive histogram equalization.

Contrast enhancement of the measured image may comprise global enhancement.

Producing the sharpened image may comprise using a user to decide a required level of sharpening. Using the user may comprise producing a series of images having different levels of sharpening, presenting the images to the user and allowing the user to choose the desired level of sharpening.

According to a second aspect of the present solution there is provided a computer readable media storing program instructions which, when executed, perform the method of the first aspect of the present solution such as receiving a measured image, producing a sharpened image by filtering the measured image to increase its sharpness, transforming the sharpened image using at least one selected geometric transformation.

According to a third aspect of the present solution there is provided a system for processing an image comprising

a receiving module which receives a measured image,

a sharpening module which produces a sharpened image by filtering the measured image to increase its sharpness, and

a transformation module which transforms the sharpened image using at least one selected geometric transformation.

The measured image may be acquired by an imaging device. The imaging device may be any of a camera, a microscope, a telescope, a thermal camera. The measured image may be acquired by a medical imaging device. The medical imaging device may be any of a scanning laser ophthalmoscope, a scanning laser ophthalmoscope in association with an optical coherence tomography device, a fundus camera, a magnetic resonance imaging (MRI) scanner, a computer tomography (CT) scanner, a positron emission tomography (PET) scanner, an ultrasound scanner, an endoscope, an X-ray imaging device.

According to a fourth aspect of the present solution there is provided an imaging device comprising the computer readable media of the second aspect of the present solution.

According to a fifth aspect of the present solution there is provided an imaging device comprising the system for processing an image of the third aspect of the present solution.

The imaging device may be any of a camera, a microscope, a telescope, a thermal camera. It will be appreciated that these are examples of imaging devices in which the present solution may be incorporated and that the present solution may be incorporated into other imaging devices.

According to a sixth aspect of the present solution there is provided a medical imaging device comprising the computer readable media of the second aspect of the present solution.

According to a seventh aspect of the present solution there is provided a medical imaging device comprising the system for processing an image of the third aspect of the present solution.

The medical imaging device may be any of a scanning laser ophthalmoscope, a scanning laser ophthalmoscope in association with an optical coherence tomography device, a fundus camera, a MRI scanner, a CT scanner, a PET scanner, an ultrasound scanner, an endoscope, an X-ray imaging device. It will be appreciated that these are examples of medical imaging devices in which the present solution may be incorporated and that the present solution may be incorporated into other medical imaging devices.

The present solution focusses, not on improvements of the sampling process of the measured image, but on directly altering the measured image to boost its sharpness through contrast enhancement. The resultant sharpened image is then transformed and presented to a user.

Many non-medical and medical applications exist where a geometric transformation of a measured image is required, which is likely to impact the image quality. In medical imaging, image stacking in MRI, CT and PET scanners and curvature correction in anterior segment imaging of the eye for corneal measurements requires geometric transformation and introduces image degradation. In non-medical applications, stitching and horizon correction of photographs from digital consumer cameras and mobile phone cameras requires geometric transformation and introduces image degradation. An aim of the present solution is to increase the image quality in these measured images. For example, increasing the image quality of retinal images can improve the diagnostic capability of medical professionals to diagnose diseased states of the human retina.

### BRIEF DESCRIPTION OF DRAWINGS

Embodiments of the present solution will now be described by way of example only with reference to the accompanying drawings, in which:

FIG. 1 is a schematic representation of a system for processing an image according to the third aspect of the present solution;

FIG. 2 is a flow chart representation of the method of processing an image according to the first aspect of the present solution, and

FIG. 3 is a schematic representation of a measured image, a sharpened image and a transformed image produced in the method of FIG. 2.

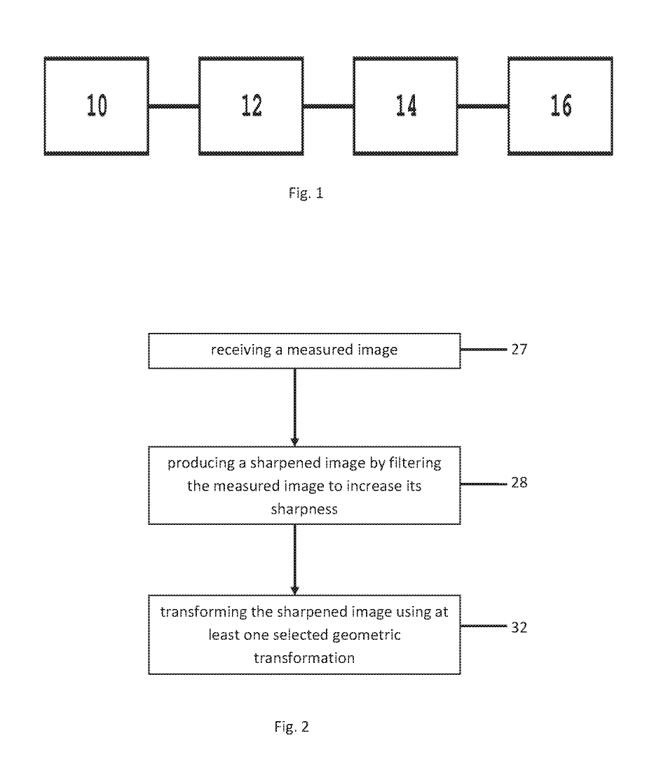

Referring to FIG. 1, a system for processing an image 1 comprises a receiving module 10, a sharpening module 12 and a transformation module 14. The system comprises a further module 16. The receiving module 10 receives a measured image acquired by an image sensor such as any imaging device e.g. a camera or any medical imaging device. The sharpening module 12 produces a sharpened image by filtering the measured image to increase its sharpness. The sharpened image is passed to the transformation module 14 which transforms the sharpened image using at least one selected geometric transformation. The transformed image is passed to the further module 16 which displays the image to a user to enable interpretation of the image, for example to obtain a medical diagnosis. The module 16 may also process the transformed image using a computer algorithm for further enhancement of the image, integration of the image with other image data (e.g., registration) or for the extraction of information from the image.

Referring to FIG. 2, the method of processing an image comprises receiving a measured image 27, producing a sharpened image by filtering the measured image to increase its sharpness 28, and transforming the sharpened image using at least one selected geometric transformation 32. Filtering the measured image to increase its sharpness comprises contrast enhancement of the measured image. Contrast enhancement of the measured image comprises determining a plurality of regions of interest of the image, characterising contrast between image intensity of a region of interest and image intensity of at least one adjacent region of interest and adjusting the image intensity in the region of interest or adjusting the image intensity in the at least one adjacent region of interest or adjusting the image intensity in the region of interest and the at least one adjacent region of interest to enhance the contrast between the image intensity of the region of interest and the image intensity of the at least one adjacent region of interest. Characterising the contrast between the image intensity of the region of interest and the image intensity of the at least one adjacent region of interest comprises measuring the second derivative of the image intensity of the region of interest and measuring the second derivative of the image intensity of the at least one adjacent region of interest.

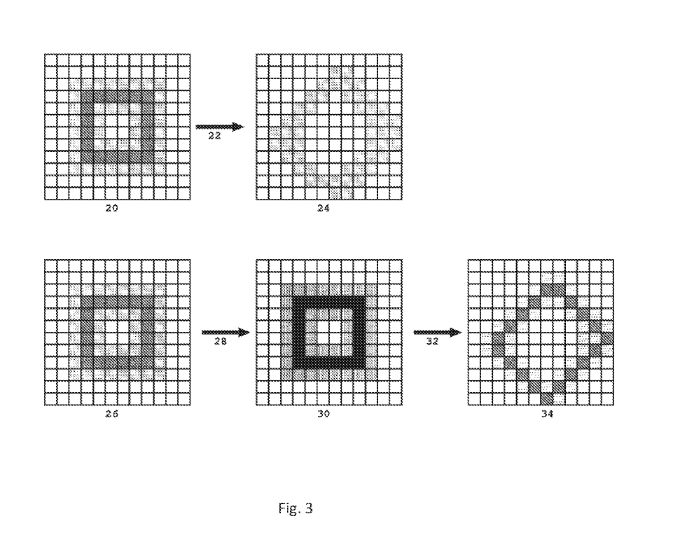

Referring to FIG. 3, the issue of reduced contrast and sharpness in measured images is illustrated. In the prior art, a measured image 20, comprising a series of squares of differing image intensities, is geometrically transformed by rotating it 22. This causes a reduction in contrast of the edges of the transformed image 24 and leads to a perception of loss of sharpness.

When the method of the present solution is used, the measured image 26, comprising the same series of squares of differing image intensities, is filtered 28 to increase its sharpness to produce a sharpened image 30. The filtering enhances contrast between the squares. The resulting sharpened image 30 is then geometrically transformed by rotation 32. The resultant transformed image 34 has greater contrast between the squares and sharper edges than the image 24 produced without the method of the present solution.

1. A method of processing an image comprising receiving a measured image, producing a sharpened image by filtering the measured image to increase its sharpness, transforming the sharpened image using at least one selected geometric transformation.

2. A method according to claim 1 in which filtering the measured image to increase its sharpness comprises contrast enhancement of the measured image.

3. A method according to claim 2 in which contrast enhancement of the measured image comprises determining a plurality of regions of interest of the image,
characterising contrast between image intensity of a region of interest and image intensity of at least one adjacent region of interest, and adjusting the image intensity in the region of interest or adjusting the image intensity in the at least one adjacent region of interest or adjusting the image intensity in the region of interest and the at least one adjacent region of to enhance the contrast between the image intensity of the region of interest and the image intensity of the at least one adjacent region of interest.

4. A method according to claim 3 in which adjusting the image intensity of the region of interest comprises changing image intensity of one or more edge sections of the region of interest of the image.

5. A method according to claim 3 in which adjusting the image intensity of the at least one adjacent region of interest comprises changing image intensity of one or more edge sections of the at least one adjacent region of interest of the image.

6. A method according to claim 3 in which characterising the contrast between the image intensity of the region of interest and the image intensity of the at least one adjacent region of interest comprises measuring the second derivative of the image intensity of the region of interest and measuring the second derivative of the image intensity of the at least one adjacent region of interest.

7. A method according to claim 2 in which contrast enhancement of the measured image comprises
determining a plurality of regions of interest of the image,
characterising image intensity of the plurality of regions of interest,
contrast stretching of the plurality of regions of interest by choosing a desired level of sharpening, calculating a scaling function using the level of sharpening and the characterisation of the image intensity of the plurality of regions of interest, and using the scaling function to change the image intensity of the plurality of regions of interest.

8. A method according to claim 2 in which contrast enhancement of the measured image comprises unsharp masking of the image.

9. A method according to claim 2 in which contrast enhancement of the measured image comprises convolution between the image and a kernel.

10. A method according to claim 2 in which contrast enhancement of the measured image comprises contrast limited adaptive histogram equalization.

11. A method according to claim 2 in which contrast enhancement of the measured image comprises global enhancement.

12. A method according to claim 1 in which producing the sharpened image comprises using a user to decide a required level of sharpening.

13. A method according to claim 12 in which using the user comprises producing a series of images having different levels of sharpening, presenting the images to the user and allowing the user to choose the desired level of sharpening.

14. An image processing computer program product, tangibly embodied on a non- transitory computer readable medium, the computer program product including instructions for causing a computer to execute
receiving a measured image,
producing a sharpened image by filtering the measured image to increase its sharpness, and transforming the sharpened image using at least one selected geometric transformation.

15. A system for processing an image comprising
a receiving module which receives a measured image,
a sharpening module which produces a sharpened image by filtering the measured image to increase its sharpness, and
a transformation module which transforms the sharpened image using at least one selected geometric transformation.

16. An imaging device comprising an image processing computer program product, tangibly embodied on a non-transitory computer readable medium, the computer program product including instructions for causing a computer to execute
receiving a measured image,
producing a sharpened image by filtering the measured image to increase its sharpness, and transforming the sharpened image using at least one selected geometric transformation.

17. An imaging device comprising
a system for processing an image comprising:
a receiving module which receives a measured image,
a sharpening module which produces a sharpened image by filtering the measured image to increase its sharpness, and
a transformation module which transforms the sharpened image using at least one selected geometric transformation.

18. An imaging device according to claim 16 comprising any of a camera, a microscope, a telescope, a thermal camera.

19. An imaging device according to claim 17 comprising any of a camera, a microscope, a telescope, a thermal camera.

20. A medical imaging device comprising an image processing computer program product, tangibly embodied on a non- transitory computer readable medium, the computer program product including instructions for causing a computer to execute
receiving a measured image,
producing a sharpened image by filtering the measured image to increase its sharpness, and transforming the sharpened image using at least one selected geometric transformation.

21. A medical imaging device comprising a system for processing an image comprising
a receiving module which receives a measured image,
a sharpening module which produces a sharpened image by filtering the measured image to increase its sharpness, and
a transformation module which transforms the sharpened image using at least one selected geometric transformation.

22. A medical imaging device according to claim 20 comprising any of a scanning laser ophthalmoscope, a scanning laser ophthalmoscope in association with an optical coherence tomography device, a fundus camera, a magnetic resonance imaging scanner, a computer tomography scanner, a positron emission tomography scanner, an ultrasound scanner, an endoscope, an X-ray imaging device.

23. A medical imaging device according to claim 21 comprising any of a scanning laser ophthalmoscope, a scanning laser ophthalmoscope in association with an optical coherence tomography device, a fundus camera, a magnetic resonance imaging scanner, a computer tomography scanner, a positron emission tomography scanner, an ultrasound scanner, an endoscope, an X-ray imaging device.
